(19) United States
(12) Patent Application Publication
(10) Pub. No.: US 2021/0327008 A1
(43) Pub. Date: Oct. 21, 2021

(54) SYSTEMS AND METHODS FOR AUTOMATED WILL CREATION, VERIFICATION OF BENEFICIARIES, AND PASSING ASSETS THROUGH A BORDERLESS FINTECH ECOSYSTEM

(71) Applicant: Ali Khalil Salah, San Francisco, CA (US)

(72) Inventor: Ali Khalil Salah, San Francisco, CA (US)

(21) Appl. No.: 17/361,169

(22) Filed: Jun. 28, 2021

Related U.S. Application Data
(60) Provisional application No. 63/044,961, filed on Jun. 26, 2020.

(51) Int. Cl. G06Q 50/18; G06F 9/451

(52) U.S. Cl. CPC G06Q 50/186; G06F 9/451

(57) ABSTRACT

A will management system and methods for automated will creation and transfer of assets through borderless fintech ecosystem. The method includes the steps of receiving the contact and verification details of the beneficiaries at the time of will creation. The beneficiaries can be contacted post death of the testator and invited to claim the assets listed in the will. Beneficiaries can be verified, including traditional asset (real estate property, currency, bonds, stocks, shares, vehicles, precious metal, funds, tangible assets, and like) and non-traditional assets in particular include the assets of which ownership and transfer includes cryptography technology, blockchain technology, and such assets are generally decentralized or are borderless.

### CROSS-REFERENCE TO RELATED APPLICATIONS

This application claims priority from the U.S. provisional patent application Ser. No. 63/044,961, filed on Jun. 26, 2020, which is incorporated herein by reference in its entirety.

### FIELD OF INVENTION

The present invention relates to a system and method for automated will creation and verification of the beneficiaries of a will, and more particularly, the present invention relates to a system and method that can automate will creation, verify the beneficiaries of the will, prevent identity theft and frauds, and transfer of assets.

### BACKGROUND

Will is an important document and a duty, and expert advice that most people should have a will. However, writing a will can be a daunting task, and because of which very few people write a will. The primary and time-consuming task in writing the will can be listing the assets. A testator may use professional services, such as accountants or an attorney to summarize the assets for the testator. If creating a will can be overwhelming, claiming and transfer of the inheritance can become more troublesome. For example, the beneficiaries may not be aware of the will or the inheritance, and so may never claim the inheritance. Additionally, the cases of identity theft and frauds are also not uncommon. Such a problem exists for a long time, but no efforts have been made in the art to resolve the aforesaid problems in the art. Transferring non-traditional assets as inheritance is another major issue that is unsolved in art.

The system/process is founded and based on a concept called “Heirified” by the inventor Ali Khalil Salah who is heavily involved in the cryptocurrency-fintech space. Asking himself a simple question, “What will happen to my cryptocurrency and other assets when I die?” After doing research Ali has noticed major flaws, ones that would come to be a major unsolved issue. Ali noticed all exchanges, brokerages, and banking especially the ones affiliated with crypto currency do not allow listing beneficiaries or some sort of way to pass on assets. And worst yet, they aren't prepared or know how to handle the issue. In short, when we are gone and every other crypto trader is gone, all their cryptocurrencies and hard work will be stuck on the exchange forever in a company located offshore and able to get away with asset theft due to being unregulated, even in a regulated country like the United States has plenty of complaints from major licensed companies that are just as bad. Traders will be left unable to pass on their assets to their family because the system is set up to fail. It is common for people to be private about their finances and are not willing to tell even their families. Leaving families clueless about the assets or how to acquire the assets. Heirified was derived from the word's “Heir” and “Verified,” combined to form the word “Heirified” which simply means verified heirs. Ali was able to come up with a solution to pass on all traditional and non-traditional assets of the deceased with or without a will and with or without the knowledge of their families on a global scale. Ali has created a Trust-less system based on verification and engineered to be fail-proof through a completely legal borderless fintech ecosystem that is Heirified.

Thus, a long and unsolved need is there for a system and method that can overcome the aforesaid drawbacks and limitations with will creation and distributing the inheritance to beneficiaries.

The terms “user” and “testator” are interchangeably used hereinafter and refer to a person creating or willing to create a will using the disclosed system. Any type of will can be created using our system living will, joint will, holographic will, last will, pour-over will, testamentary trust will, online will, and etc.

Traditional assets hereinafter refer to standard assets that that are recognized in most of the countries and has established procedures for their ownership and transfer. The traditional assets include real estate property, currency, bonds, stocks, shares, vehicles, precious metal, funds, and like. Tangible assets hereinafter refer to traditional assets.

Non-traditional assets hereinafter refer to new assets that have no standardized procedures for their ownership and transfer, and their recognition among different countries vary. Such assets include cryptocurrency, non-fungible token (NFT), Decentralized finance (DeFi), stable coins, tokens, alt-coins, Smart Contracts, decentralized domain names (Unstoppable domains, etc.). The non-traditional assets in particular include the assets of which ownership and transfer includes cryptography technology, blockchain technology, and such assets are generally decentralized or are borderless.

The phrase “biometric data” hereinafter refers to a feature for human body that can be used for identification and include finger print, finger thermal print, IRIS scan, retinal scan, facial features, DNA fingerprint, and like biometric parameters known to a skilled person.

The phrase “access details” hereinafter refers to a secret data used to confirm an identity of a user for gaining access to a secured application. The “access details” includes unique IDs, password, passcode, seed phrases, encrypted keys, account numbers, authentication token, digital signatures, and like.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system and method for automating the will creation.

It is another object of the present invention that any change in the assets can be tracked.

It is still another object of the present invention that the will can be revised or amended to incorporate any changes in the assets, any change in beneficiaries, or allocation to the beneficiaries.

It is yet another object of the present invention that the beneficiaries of the will can be verified to prevent any identity theft or fraud.

One general aspect includes a method for creating and managing a will. The method also includes presenting, a user interface on a user device, by an interface module upon execution by a processor of the will management system, the interface module implemented within the will management system; receiving, through the user interface, user details, details of one or more beneficiaries, and first details of assets, through the user interface, by a registration module upon execution by the processor, the registration module implemented within the will management system; fetching, a second details of assets from one or more service provider's servers based on the user details and the first details of assets, by a draft module upon execution by the processor, the draft module implemented within the will management system, the one or more service provider's servers are external to the will management system; processing, the first details of asset and the second details of assets to obtain a list of assets; presenting a will creation template implemented within the user interface, by the draft module upon execution by the processor, the will creation template may include the list of assets and the one or more beneficiaries, the will creation template configured to permit linking one or more assets of the list of assets to the one or more beneficiaries, the will creation template further may include a plurality of placeholders configured to receive the user details and details of the one or more assets of the list of assets linked to the one or more beneficiaries; and processing the will creation template with the user details and the details of the one or more assets linked to the one or more beneficiaries to obtain a will. Include:

Implementations may include one or more of the following features. The method where the method further may include the steps of: notifying, by an administrative module upon execution by the processor, at least one beneficiary of the one or more beneficiaries about the will, the administrative module implemented within the will management system; receiving, from the at least one beneficiary, details of the at least one beneficiary, by the administrative module upon execution by the processor, transferring, at least one asset of the one or more assets linked to the at least one beneficiary, by the administrative module upon execution by the processor, to the at least one beneficiary. The asset can be a non-traditional asset and the method may further include the step of receiving access details, through the user interface, by the registration module upon execution by the processor, the access details configured to provide access to the non-traditional assets such as social media and other accounts, where the access details can be transferred by the administrative module to the at least one beneficiary. The method further may include the steps of upon receiving the details of at least one beneficiary, also receiving by the administrative module at least one biometric data of the at least one beneficiary, where the access details can be unencrypted based on at least one biometric data of the at least one beneficiary. It is to be understood that registration module may also have an option to add details of contact persons, who are not beneficiaries but could be guardians of the beneficiaries, or persons that can forward any notification to the beneficiaries. The contact persons can be service providers, such as associates of attorneys, accountants of the beneficiaries or family members, and like. The disclosed system for verification of the beneficiaries can also receive biometric data of the contact persons. As shown in FIG. 5 and FIG. 7, testators and users may have multiple mail addresses (home address, PO box, etc.) (for business addresses and/or residential addresses) all around the world where essential documents can be received, therefore, it is extremely important to list and authorize a trusted contact, beneficiary, attorney, etc. in the case of an emergency (such as severe health, illness, etc.) especially death.

In one aspect, the method further may include the steps providing an attorney interface, by the interface module upon execution by the processor; receiving verification of the details of the at least one beneficiary through the attorney interface; and receiving an approval for the transfer of the at least one asset to the at least one beneficiary, through the attorney interface, where the transfer is made upon receiving the approval.

In one aspect, the method further may include the steps of providing an attorney interface, by the interface module upon execution by the processor; receiving the will, by the attorney interface, where the attorney interface may permit editing the will; receiving from the attorney interface the edited will or an acknowledgment of the receipt of the will; and presenting, on the user interface, the edited will, or the acknowledgment. The attorney interface may permit an attorney linked to the user, to track and monitor changes, updates, and like activities on the account of the user. Similarly, the user interface may also keep a track on activities of the attorney related to the user. This can be served for legal purposes globally by connecting verified users with an attorney for all legal needs, agreements, notarization, database, etc. A list of attorneys can be added online and every user is already verified as shown in FIG. 3.

Requested documents are required to notarized, apostilled, legally certified documents must be verified to prevent fraud and to make sure it was notarized correctly and legally. The preferred language for all documents is in English. However, English is not the primary language for all users. For example: The Middle-East and North Africa (MENA) region, consisting of nearly 20 countries, does not have English as the primary language. A scenario to take into account: Assuming a user from the United Kingdom listed a beneficiary as his sister who lives in Egypt (Egypt and its government entities operate in Arabic) the benefactor is required to send in documents that are notarized to the UK however the UK is an English speaking country. The UK legal system requires all documents to be translated from Arabic to English before being notarized. Upon mailing the documents, it's preferred that they use international mail with an efficient tracking number in case it gets lost. All documents must be translated into the receiving country's primary language, notarized, and apostilled through a government entity. We may request to verify the notarized document ourselves directly, legally and/or online. A government entity in a specific country or jurisdiction has the duty to translate all documents into English if needed. It is to be noted that expired documents are unacceptable and have a maximum limit of 6 months. It is also important to know, in order to avoid any issues throughout the process (for example, during Covid-19, all governments got backlogged for over 6 months and workers had to be laid off), this will clearly affect the process in terms of time and the document may not be received at the requested time frame to the government entity requesting it for the same reasons. The listed beneficiary will be required to redo the process. Missing or late documents may receive requests from the sender/receiver of the document's current location. Proof may be required in order for the transporter/shipper to clarify and/or solve the situation (the transporter/shipper may be at fault). The printed date of the document, when it was made, when it shipped, and when it was notarized or apostilled. The date of issue will always be the main date to be based on. In worst case scenarios, proof will be required. A request for an issue date, notarized/apostilled date may be required. To avoid issues in the process while the documents are being sent in the mail, a tracking number will be recommended to track the mail (it is common for mail to get stuck for a very long period of time or even forever unless informed). The person that notarized or apostilled the document will provide the start/issued date or the date of notarization. The date a document was signed by a recipient may be required to send proof of why it was late, when it was done, when the document was received, or sent out. A link to the email thread (not just a screenshot) can be a proper source for proof. Sometimes everything is done perfectly, however, the document can simply become stuck for a long time. A document can be checked through the website based on jurisdiction using the document number or reference number/ID. A scenario to take into account, when a benefactor is requested to upload a photo ID, assuming the beneficiary is the sister who just died, the deceased beneficiary to be notified had a husband who wanted to take advantage by committing fraud by way of claiming the inheritance for himself. The husband has access to all the information of the deceased beneficiary and managed to obtain a fraudulent passport, legal documents, or an authentic passport (which can be done by a corrupt official). Knowing that corruption exists in countries and assuming, in this case, the husband had all the information and documentation required, the multiple authentication methods, specifically the biometric authentication system, can serve as a fraud prevention. In a second scenario, before mailing sensitive legal documents, it is required to upload a picture of the notarized documents (with a tracking number) before mailing. An uploaded digital copy of the mentioned documents or picture of the documents is required until the notarized document is received through the mail.

In one aspect, while processing the will creation template, the method may further include the steps of capturing audio and video of a user through a camera and microphone coupled to the will management system; and determining, the mental state of the user by analyzing the audio and video.

In one aspect, the method may further include the steps of tracking a change in the list of assets by the draft module upon execution by the processor; receiving, an amendment in the will through the user interface, by the draft module; and processing the amendment to obtain a revised will.

One general aspect includes a method for managing a will and transfer of assets. The method also includes presenting, a user interface on a user device, by an interface module upon execution by a processor of the will management system, the interface module implemented within the will management system; receiving, through the user interface, user details, details of one or more beneficiaries, and a will, through the user interface, by a registration module upon execution by the processor, the registration module implemented within the will management system, the user details may include social security number or any unique identification number issued by a government agency, such as passport number, driving license number. The user may also be required to upload a document of along with the document number, for example, the users uploading a passport number can also upload a copy of the passport as a visual identification document. Similarly, an address proof can also be uploaded. Thereafter, an image of a user showing the will to a camera can also be uploaded to the disclosed system.

In a preferred implementation, the disclosed system can generate temporary transaction ID for each transaction and a final unique transaction ID can be generated for the finalized will. This transaction ID can be printed on each page of the printed will document. Moreover, the transaction ID can be converted to a suitable QR code and printed on each page of the printed will document. In one case, the transaction ID can be based on a digital signature used to protect the digital will from tampering and to ensure legality of the digital will. The user can optionally, put the signature on the printed will and the user with will in hand can be captured as images or video by the disclosed system. The system may instruct the user to change the position of the will relative to the camera, such as the QR code can be read from the images the system and simultaneously, at least a face of the user can be captured with the will. Additionally, the signing of the printed will by the user in presence of the witnesses can also be captured. The witnesses can physically present or can be invited on a video conference implemented by the disclosed system. Similarly, an attorney can also be present at the time of signing the printed will at the time of signing, wherein the attorney can be present physically with the user or vitally join the video conference with the witnesses. Will can also be secured by a time verification code by scanning/sending the code.

Implementations may include one or more of the following features. The method where the method further may include the steps of notifying, by an administrative module upon execution by the processor, at least one beneficiary of the one or more beneficiaries about the will, the administrative module implemented within the will management system; receiving, from the at least one beneficiary, details of the at least one beneficiary, by the administrative module upon execution by the processor, transferring, at least one asset of the user linked to the at least one beneficiary, by the administrative module upon execution by the processor, to the at least one beneficiary. At least one asset can be a non-traditional asset and the method further may include the steps of receiving access details, through the user interface, by the registration module upon execution by the processor, the access details configured to provide access to the non-traditional asset, where the access details is transferred by the administrative module to the at least one beneficiary. The method further may include the step of upon receiving the details of at least one beneficiary, also receiving by the administrative module at least one biometric data of the at least one beneficiary, where the access details are unencrypted based on at least one biometric data of the at least one beneficiary, by the administrative module upon execution by the processor. The method further may include the steps of providing an attorney interface, by the interface module upon execution by the processor; receiving verification of the details of at least one beneficiary through the attorney interface; and receiving an approval for the transfer of at least one asset to the at least one beneficiary, through the attorney interface, where the transfer is made upon receiving the approval. Implementations of the described techniques may include hardware, a method or process, or computer software on a computer-accessible medium.

In one aspect, the disclosed system can virtually provide an access to transact the digital assets to the beneficiaries. Instead of giving the access details, the beneficiaries can virtually access the account through the disclosed system for transferring the assets to their own account.

In one aspect, both the traditional and non-traditional assets can be transferred nationally and globally.

These and other objects and advantages of the embodiments herein and the summary will become readily apparent from the following detailed description taken in conjunction with the accompanying drawings.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is an environmental diagram showing the will management system interacting with a service provider's device, user device, and an attorney device through a network, according to an exemplary embodiment of the present invention.

FIG. 2 is a block diagram illustrating an architecture of the will management system, according to an exemplary embodiment of the present invention.

FIG. 3 shows an interface displayed on the user device for user verification, add an attorney, and one or more beneficiaries, according to an exemplary embodiment of the present invention.

FIG. 4 shows a form implemented within the user interface for KYC verification, email and phone verification, and the creating will, according to an exemplary embodiment of the present invention.

FIG. 5 shows a form implemented within the user interface for listing a beneficiary, trusted contact, witness, or other. according to an exemplary embodiment of the present invention.

FIG. 6 shows a form implemented within the user interface for businesses and it's officers, according to an exemplary embodiment of the present invention.

FIG. 7 shows another form implemented within the user interface for listing a beneficiary, according to an exemplary embodiment of the present invention.

FIG. 8 shows a form implemented within the user interface for adding a non-traditional asset specifically for the addition of NFTs, according to an exemplary embodiment of the present invention.

FIG. 9 shows a form implemented within the user interface for adding another non-traditional asset specifically for the addition of cryptocurrency, according to an exemplary embodiment of the present invention.

FIG. 10 shows a KYB form for non-profit organizations, according to an exemplary embodiment of the present invention.

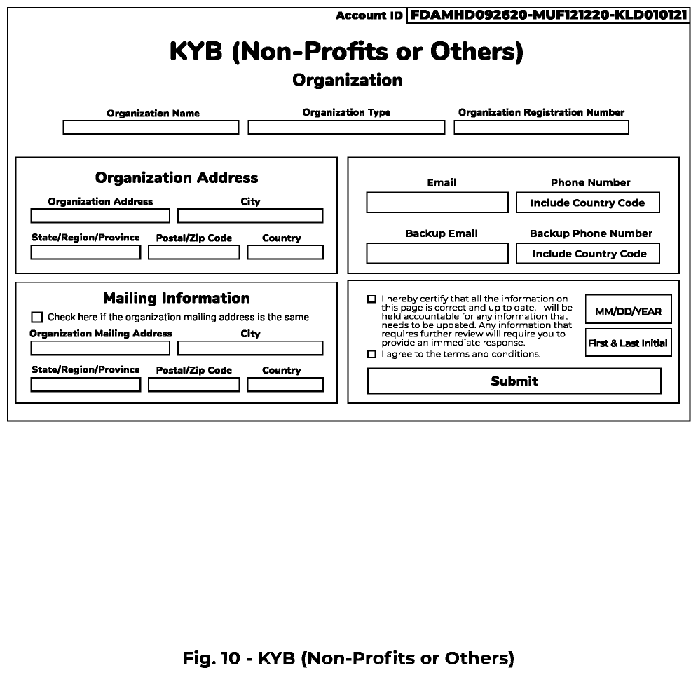

FIG. 11 shows a form to list attorneys, according to an exemplary embodiment of the present invention.

FIG. 12 shows steps in the beneficiary verification process, according to an exemplary embodiment of the present invention.

FIG. 13 shows a form for claimed deceased account for the beneficiary to claim assets, according to an exemplary embodiment of the present invention.

FIG. 14 shows steps in the attorney verification process, according to an exemplary embodiment of the present invention.

FIG. 15 shows an embodiment of the user interface to create and add a digital will, according to an exemplary embodiment of the present invention.

FIG. 16 shows a form for donation to an individual, trust, foundation, and non-profit organizations, according to an exemplary embodiment of the present invention.

FIG. 17 shows a form implemented within the user interface for creating a trust for pets, according to an exemplary embodiment of the present invention.

FIG. 18 shows steps in the verification of non-profit organization, according to an exemplary embodiment of the present invention.

FIG. 19 shows a chat interface, according to an exemplary embodiment of the present invention.

FIG. 20 shows a notification status interface, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Disclosed is a system and method for automating the creation of will and verification of the beneficiaries of the will. The disclosed system and method make the creation and management process of will easier, efficient, and quicker. Moreover, the disclosed system and method can provide for verification of the beneficiaries to ensure that the assets can be passed to the right beneficiaries and minimize the hassles in the post-death inheritance process. Moreover, the disclosed system can provide for tracking any changes in the assets and generating notifications to update the will. Any digital estate plan and asset management plan can be digital, virtual, or tangible can be updated immediately simply through phone, apps, and online. Besides tracking the assets that disclosed system can also track the activities of the user, attorney, beneficiaries. Such activities can be logged with date and time. System can seek updates from the user, attorney, and the beneficiaries, and such timings for such updates can be predefined in the system. The updates can also be about wellbeing of the user and if the user is alive or not. For example, if the user is not active on emails, bank accounts, and like for a long time, the disclosed system can seek updates from beneficiaries and attorney about the user. The disclosed system and method can also provide for the transfer of assets fairly. The non-traditional assets and overseas assets can be easily transferred nationally and globally. The disclosed system can provide for tracking the changes in non-traditional assets and their transfer to the beneficiaries.

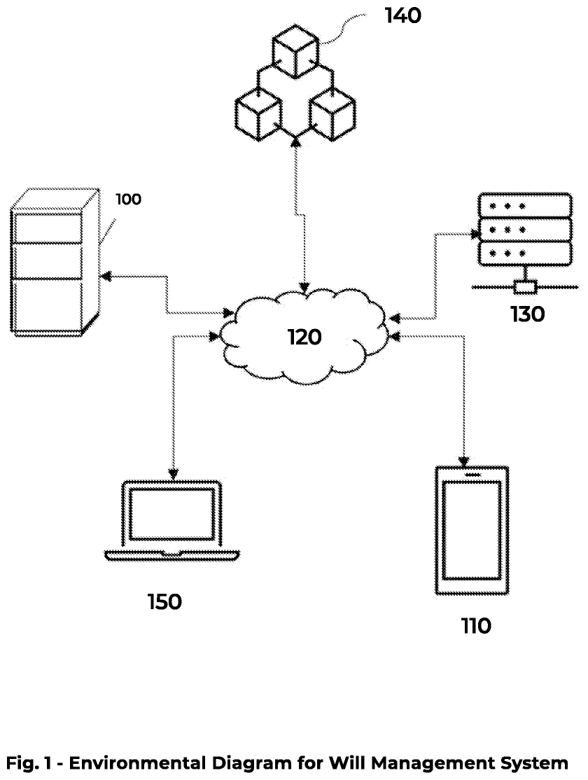

Now referring to FIG. 1, which is a block diagram showing the disclosed will management system 100 that can interact with one or more user devices 110 through a network 120. The user devices can be computer devices with network connectivity, and examples of the user device may include a smartphone, laptop, desktop, tablet computer, personal digital assistant (“PDA”), smart watches like Apple watch and Android watch, health sensors like Healthwatch, health bands, hardware wallets, devices installed on cars (anything else that functions the same way, cars have computers, blockchain technology, and digital identity). Smart watches can also be tracked and provides for taking the biometric of the user. Biometric authentication and multiple security methods are based on Artificial Intelligence (A.I.), machine learning, deep learning, Internet of Things (IoT), blockchain, etc. and will be used to accurately gather information efficiently while preventing fraud, eliminating wasted time, and offering a more diverse set of methods to login without having to type a password. The option to use passwords will still be available. The smart watches can also provide for secured access to the disclosed system, wherein the user need to be wearing the smart watch to gain access to the disclosed system. Moreover, notification of the transactions on the system can be sent to the user devices, such as smart watches. The computer device can include an operating system, such as but not limited to Android, iOS, Windows, macOS, blackberry, and Linux. Smartwatches also offer the ability to track health giving the ability to detect multiple signs of health giving the ability to send the information to the connected brokerage and the listed “trusted person” may be contact to confirm if the user is sick or deceased before sending an official notice to contact listed beneficiaries. For additional security purposes the smart watch can also be used to block certain activities made to their account. Limit access to certain devices only thus notifying the user of any unwarranted use. The user device can have an input device for receiving an input and a display for a user to interact with the disclosed will management system 100. The user device can also include a network circuitry for connecting to a network. The network can be wired or wireless network. The wired network may include DSL and optical fiber lines. The wireless network may include Bluetooth®, Wi-Fi, WiMAX, and cellular networks including GPRS, LTE, CDMA, 3G, 4G, and 5G. The network can be a secure network or an unsecured network. Also, known communication protocols can be used for communicating between the user devices and the disclosed will management system 100 on a network. Examples of security protocols that can be used include FIDO2 Authentication Standard, Pretty Good Privacy, Secure Shell (SSH), FIDO—Fast Identity Online, Client to Authenticator Protocol (CTAP/CTAP2), Extensible Authentication Protocol (EAP), Secure, Quick, Reliable Login (SQRL), Open Authorization (OAuth), Open Authorization (OAuth 2.0), Internet Key Exchange (IKE), NT LAN Manager (NTLM), System for Cross-Domain Identity Management (SCIM), Challenge Handshake Authentication Protocol (CHAP), Salted Challenge Response Authentication Mechanism (SCRAM), Key Agreement Protocol, Trust on First Use (TOFU), Key Agreement Protocol, Simple Object Access Protocol (SOAP), Representational State Transfer (RESTful API), Zero Knowledge Proof (ZKP), Kerberos, Lightweight Directory Access Protocol (LDAP), Secure Socket Shell (SSH), Messaging Layer Security (MLS), OpenID Connect (OIDC), X.509 Certificate, PIV, and OATH. The disclosed will management system 100 can also interact with different service provider's servers 130 including public and private service provides to retrieve information related to a user. Such servers can be geographically dispersed within a country and outside the country. The disclosed will management system 100 can communicate with the servers through APIs, plugin, and like method known to a skilled person for querying an external server and receiving information in response to the query, and any such method of retrieving information from the external server is within the scope of the present invention. The service providers can be banking, accounts, public registration, digital banking, brokerage exchanges, cryptocurrency exchange, trading platforms, debit cards, digital wallets, and like servers that may have information related to the assets of a user. The will management system 100 can connect to the servers through the network 120. FIG. 1 shows the user device and the service provider's servers connected through the same network for illustration purposes only, however, it is to be understood that the different devices can connect with the disclosed system through different networks and using different network communication protocols. Moreover, the same device can connect with the will management system 100 through more than one network.

The disclosed platform can require authentication the devices using known protocols, such as FIDO2 Authentication Standard, Token-Based Authentication, one time password (OTP), HOTP and TOTP, Shared Accounts, Password less Authentication, Ticket Granting Tickets (TGT), Out of Band Authentication (OOB), Risk Based Authentication (RBA), Universal 2nd Factor (U2F), Biometric Authentication, Adaptive Authentication, Time Based One Time Password (TOTP), Push Notification Authentication (Push Authentication), Privileged Access Management (PAM), Key Distribution Center (KDC), Smart Card Authentication, Step Up Authentication, Active Directory (AD), What is Two-Factor Authentication (2FA), Single-Factor Authentication (SFA), and Multi Factor Authentication (MFA). The devices can talk on secure network, such as security protocols like Pretty Good Privacy, Elliptic Curve Digital Signature Algorithm (ECDSA), Diffie Hellman Algorithm (DH), Cryptographic Hash Function (Hash), End-to-End-Encryption (E2EE), Salted Secure Hash Algorithm (SALT), Pairing Based Cryptography (PBC), Identity Based Encryption (IBE), Secret Sharing, Quantum Cryptography, Advanced Encryption Standard (AES), and Symmetric Key Cryptography can be used. The disclosed platform can also require Identity and Access Management using such tasks: Shoulder Surfing, Token-Based Authentication, Identity Governance (IG), Identity as a Service (IDaaS), Security Information and Event Management (SIEM), Active Directory Certificate Services (ADCS), Web Authentication (WebAuthn), and Identity Sprawl (Directory Sprawl). The disclosed platform can also require Federation and SSO using task such as: Active Directory Federation Services (AD FS), Security Assertion Markup Language (SAML), Single Sign On (SSO), Federated Identity Management (FIM), and Federated Identity (FID). The disclosed platform can also support the following Network Architectures: Virtual Desktop (VD), Virtual Machine (VM), Mobile Device Management (MDM), Stateless Authentication (Token-based Authentication), Stateful Cloud, Stateless Cloud, Demilitarized Zone (DMZ), Zero Trust, and Virtual Private Network (VPN). The platform can support the following Cloud Services: Security as a Service (SECaaS) and Infrastructure as a Service (IaaS).

The will management system 100 can also operably coupled to database management systems 140, such as government databases, blockchain databases (Public blockchain, Private blockchain, Consortium blockchain, federated blockchain, and Hybrid blockchain, and like to safely store the records including the will. The will management system 100 can exchange data through network 130 with the database management systems 140.

FIG. 1 also shows the will management system 100 interacting with a professional device 150. The professional can be an attorney or a person that is certified by the law to advise and assist a person to make the will and transfer of assets according to the will and include attorneys and in particular probate attorneys. The professional device can be a computer device, and examples of the professional device may include a smartphone, laptop, desktop, tablet computer, personal digital assistant (“PDA”), smart watches like Apple watch and Android watch, health sensors like Healthwatch, health bands, hardware wallets, devices installed on cars (anything else that functions the same way, cars have computers, blockchain technology, and digital identity). The computer device can include an operating system, such as but not limited to Android, iOS, Windows, macOS, Blackberry, and Linux. The computer device can have an input device for receiving an input and a display for the professional to interact with the disclosed will management system 100. The computer device can also include a network circuitry for connecting to a network. The professional's device can connect with the will management system 100 through network 130.

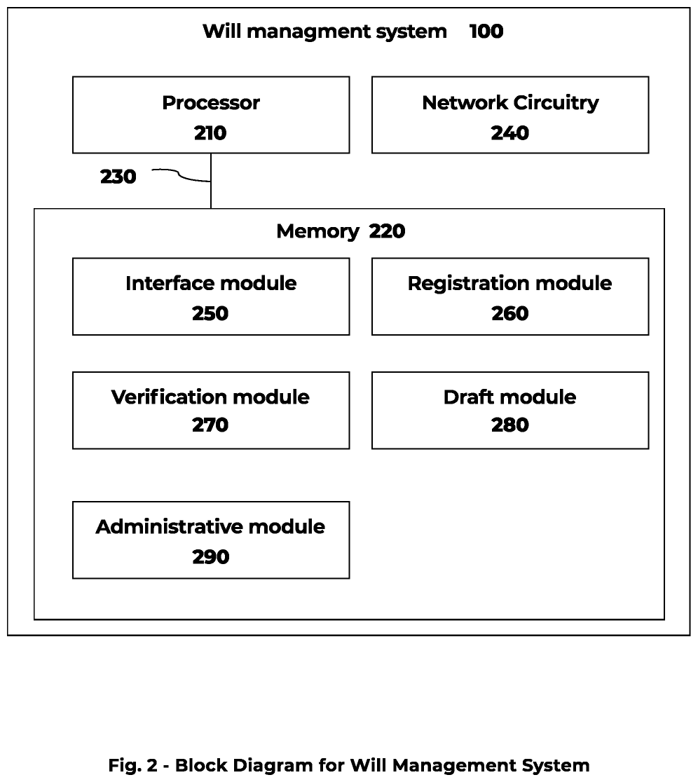

Referring to FIG. 2 which is a block diagram showing an exemplary embodiment of the computer-implemented will management system 100. The will management system 100 can include a processor 210 coupled to a memory 220 through a system bus 230. The will management system 100 may also include a network circuitry 240 coupled to the processor through the system bus 230 for connecting the will management system 100 to an external network. The processor 210 can be any logic circuitry that responds to, and processes instructions fetched from the memory 220. Suitable examples of the processors commercially available include Intel and AMD. The memory 220 may include one or more memory chips capable of storing data and allowing any storage location to be directly accessed by the processor 210. As shown in FIG. 2, the memory includes modules according to the present invention for execution by the processor 210 to perform one or more steps of the disclosed method for the creation and management of will. Memory 220 can include an interface module 250, a registration module 260, a verification module 270, a draft module 280, an administrative module 290.

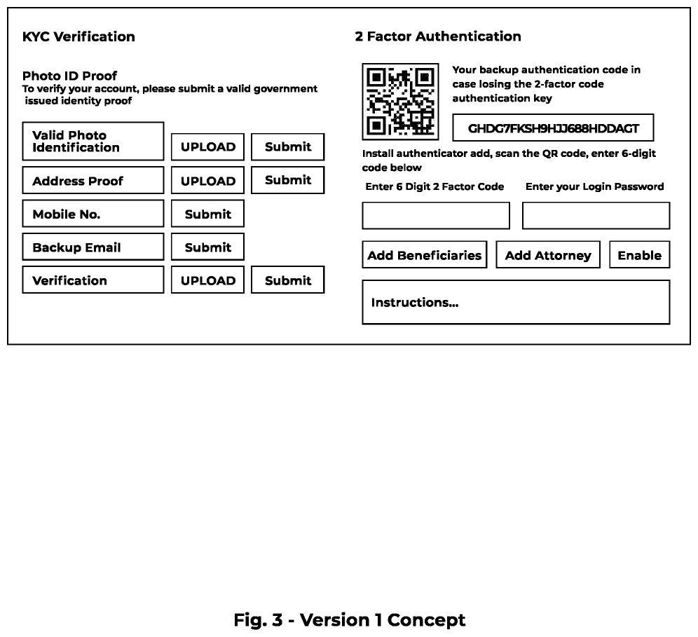

The interface module 250 upon execution by the process can provide a user interface on the user device 110. The interface can be provided as application software that can be installed on the user device 110. The application software can be developed for Android™, iOS, and any other known operating platform for mobile devices. The application software can be made available through a distribution service provider, for example, Google Play™ operated and developed by Google, and the app store by Apple. In addition to the application software, a website-based interface can also be provided through the world-wide-web. The application software can also be provided for the desktop environment, such as Windows™, Linux, and macOS. The user interface may permit interacting with a user through the user device, wherein information can be presented within the user interface by the will management system 100 and information can be received by the will management system 100 from the user. Moreover, the interface may allow the user to upload documents, photographs, and like. The interface can also display QR codes and like for the user to scan. FIG. 3 show one implementation of the user interface, wherein the user interface can provide for verification of the user. The interface can also be provided for the professional device such as for an attorney device. The attorney interface may allow an attorney to oversee an account of a user to which the attorney can be linked. Moreover, the interface module 250 can provide suitable interfaces for configuring the will management system 100 for connecting to different service provider's servers and database management servers for storing and backing up the data. The interface module 250 can also provide an admin interface that may be displayed on a display attached to the will management system 100 or any other remote display connected to the will management system 100 through a network.

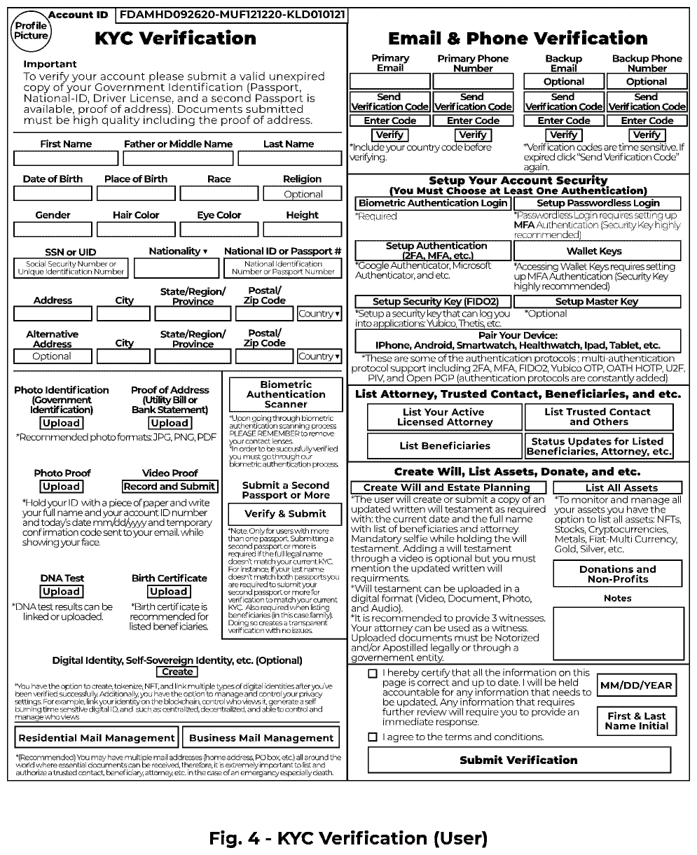

The registration module 260 upon execution by the processor can provide for the registration of a user and a professional. The user can be presented with a registration form within the user interface. Through the registration form, the registration module 260 can receive details of the user and may also create a safe login for the user for secure access to interact the will management system 100. The registration module 260 can receive details, such as but not limited to contact details including name, address, email, phone no. and like details. The registration module 260 can also receive details that may help to retrieve details related to the assets of the user and applicable state laws. Moreover, certain information can be mandatory under regulations prescribed by the law of the state, such as the KYC of the user. The registration module can first receive basic details for creating an account and a login for the user. Thereafter, the rest of the details can be received in one go, or the user can enter the details at their own pace. The registration module 260 can receive details such as age, bank details, assets details, income tax returns, and like. Moreover, the registration module can ask for more information about the user, such as religion, nationality, etc. to determine the state law applicable to the user. The registration module 260 can also receive a photograph, identity proof, address proof, photo proof, video proof, DNA test, birth certificate for verification, and for users with second passport or more passports they can be submitted, this will be able to match the full name legally with no issues. It is to be understood that not all the details can be mandatory for the user to provide. Some details, in particular, the contact details and prescribed details by the state law may be mandatory, the other details can be optional and may depend upon the requirements of the user. Moreover, many details of the user can be fetched from external servers using the details provided by the user. For example, the details of the income tax returns can be fetched by the tax identification number of the user. FIG. 4 shows a registration form presented by the user interface for receiving details from the user including race, religion, nationality, biometric data, eye color, hair color, height, and like. The user can also be provided with different option to set-up the account and authentication method for accessing the account. Email and phone no. of the user can also be verified. Users and anyone listed can have two emails and two phone numbers and non will be listed or approved unless verified through many of the security protocols for example, email, sms, mfa-auth, 2fa, call, etc. A backup email and phone no. is used in case a phone gets lost or stolen, or traveling and not being able to use the same number. The registration form can also be linked to the form for adding beneficiaries and attorneys. The user can also set-up trusts or list trusts and non-profit organizations. Link to a form for creating the will can also be provided on the form shown in FIG. 4. Shown in FIG. 4 the user has the option to add a profile picture however it can only be done in three ways: through biometric authentication, the scanned face can be used as a profile picture; another way, the user can manually upload a profile picture however the uploaded picture will be subject to the verification process in order to confirm the picture matches the user's face; the last method will have the user take a picture on the spot and in the meantime will go through a biometric authentication, the user must wait until the authentication system has successfully verified the photo matches the user. Artificial Intelligence (A.I.), machine learning, deep learning, other various technologies, etc. will be used in order to recognize and verify the user. The user's biometric scans will be stored on the servers to serve as a record. If the user would like to add additional photos, they may do so using the previously mentioned methods; a user may do this for various reasons: they might have had a beard and would like to add a new profile picture without the beard, weight gain/loss can also affect how a person looks overtime prompting for additional photos, other reasons may be applied. Lastly, using the same methods to scan and verify a user's face, Artificial Intelligence (A.I.), machine learning, deep learning, other various technologies, etc. will be able to scan physical and digital documents to prove its legitimacy and prevent fraud or fake documents.

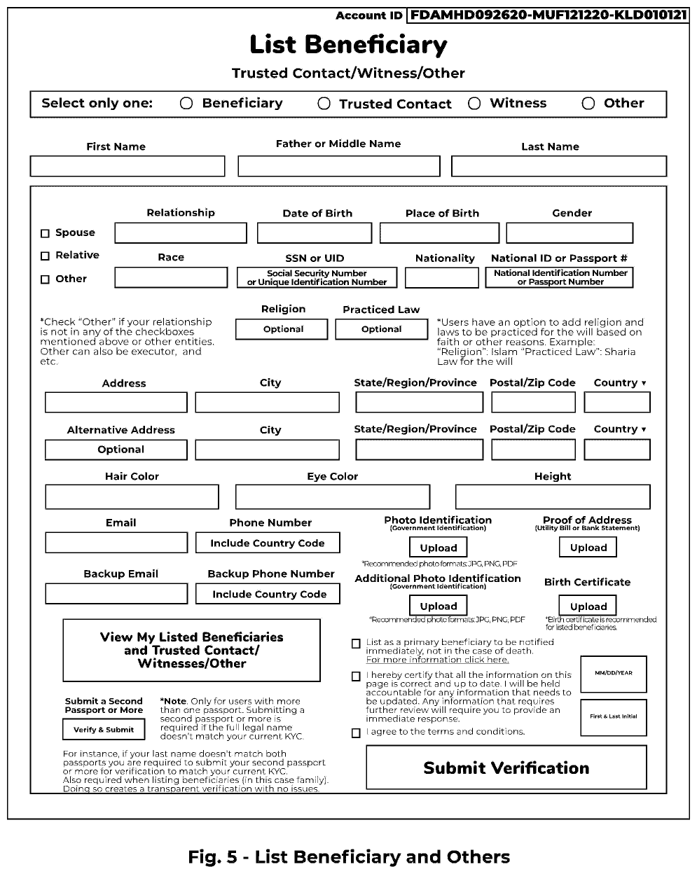

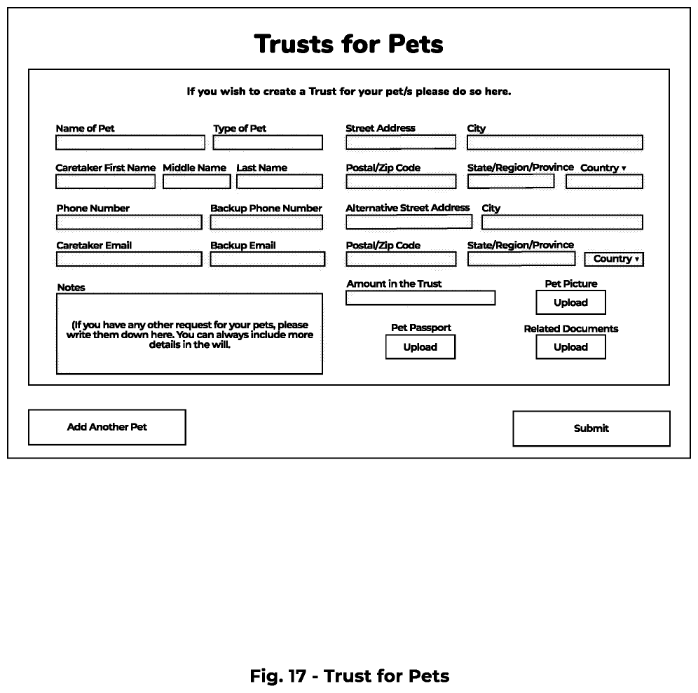

Users and anyone listed can have two emails and two phone numbers and non will be listed or approved unless verified through many of the security protocols and authentication methods offered for example, email, sms, mfa-auth, 2fa, call, etc. The backup email and phone is used incase phone gets lost or stolen, or traveling not able to use the same number since you're not able to use it or using a different cellular carrier. This helps prevent situations where a user can't access for example they're bank account bank account, brokerages, etc. Users, and anyone listed have the options to add alternative address incase mail is not sent or received from the same address or may be used as a second residence in another city or country. Alternative address can be used as backup as shown in FIGS. 5, 7, 8, 11, 16, and 17

The user can be provided with login details for secured access to the disclosed system. The login details can include a password or password-less access option can also be provided (third party hardware such as Yubikey can incorporate fingerprint. Other methods for passwordless login are mobile push, security questions, OTP emails, software OTP, PIN, biometric, U2F tokens, or tokens launched from physical devices). For example, biometric authentication can be used for gaining access. Cryptographic methods are known for secure access to a system, such as cryptographic keys configured in hardware tokens. Security protocols, as described above, can be used for the secured access to the disclosed system and will be constantly updated.

The registration module can also use digital identity (know your customer and know your business). Users can pass assets through a Tokenized Digital Identity on the Blockchain and may be used in the process as an option. This can be used to pass assets involved in non-traditional assets. Every user can receive a unique Account ID generated by the system, during registration. All types of Digital Identity (centralized, decentralized, federated, and etc.) and the term Self-Sovereign Identities (SSI) are interchangeable terms. The SSI can be used globally and for all purposes much like a passport, driver license, or general use. SSI can be used with governments for verification and identification purposes (SSN or National ID). SSI can be on the blockchain making it secure and digital (it can be offered through the internet and other forms of technology such as blockchain, artificial intelligence (A.I.), machine learning, deep learning, Internet of Things (IoT), other various technologies, etc. Users who successfully create a KYC will gain an SSI (the SSI uses the information acquired from KYC/KYB in order to create a digital identity for the user) (all data in KYC/KYB can be used as a centralized and/or decentralized identity (others terms to note: federated identity, centralized identity, distributive identity (DID), self-sovereign identities (SSI), federated identity, and centralized). Legal certification through an attorney, the government, or third party will be required as a process in attaining a verified SSI. Decentralized assets (Cryptocurrency) include: All types of cryptocurrency coins, tokens, alt-coins, stable coins, etc. as well as DeFi (Decentralized Finance), NFT (Non-Fungible Tokens), Smart Contracts, decentralized domain names (Unstoppable domains, etc.), any other blockchain, cryptocurrency, decentralized assets. The SSI can be offered as a Non-Fungible Token (NFT) or any other form of token. The SSI will serve as the user's identity for digital and physical means. In other words, a user can have a physical card, hardware, or any other physical form to hold, store, record, their SSI. The user's SSI will also be retained digitally in places such as, but not limited to; smartphones, smartwatches, health sensors like Healthwatch, health bands, tablets, computers, security keys/devices, etc. Other methods of storing an SSI can include a QR code, RFID, chip, etc. The user will be able to share their KYC, KYB, and other information to any government entity and third party. The user will have the ability to control who will see their information, what information is public versus private, what purposes their SSI is used for, and which applications can use their SSI. The user will have the ability to offer time sensitive code to allow and/or limit a certain party's viewing privileges; the user may also generate a self-burning time sensitive digital ID for temporary use. The user will be able to track and monitor the activities associated with their SSI. For example, the user will be able to see who has viewed their SSI, the time it was viewed and for how long, location of the viewer, etc. Overall, the user will have the ability to manage and control a wide list of privacy settings and be able to link multiple types of digital identities. The user will be able to use their SSI to create an account for any platform. For example, social media platforms like Facebook, Instagram, Pinterest, and even business applications like a resume. All types of digital identity, SSI, and the entire process revolving the “Heirified” system may also contribute in the research and study of DNA and the practices/products associated such as linking family trees or tracing back one's own ancestors.

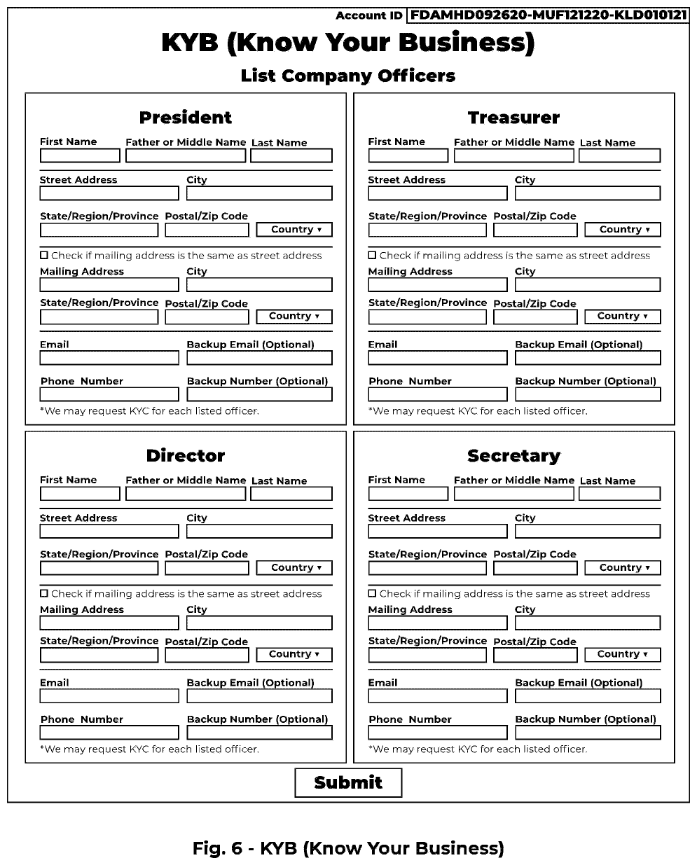

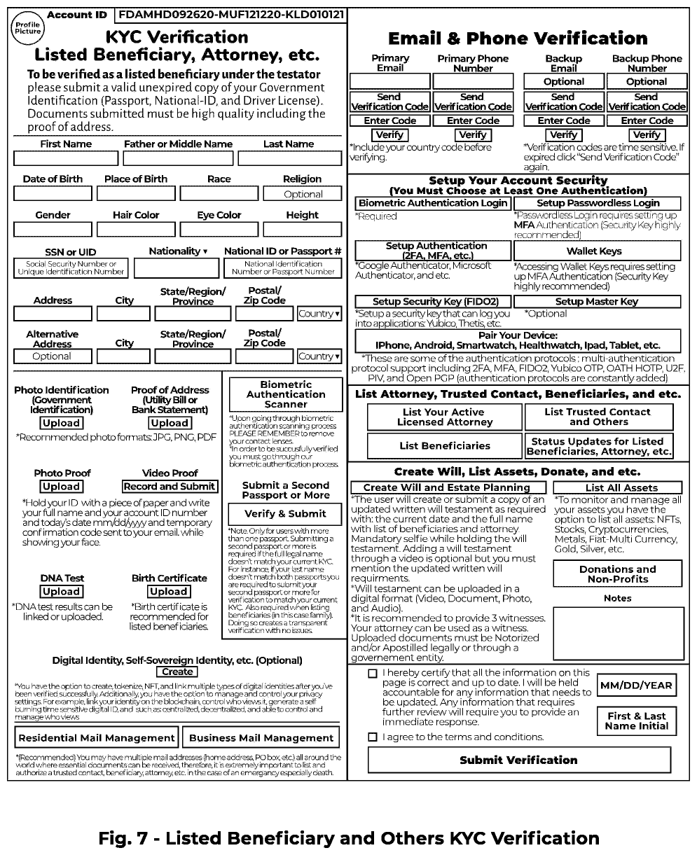

The registration module may also allow a user to add details of the beneficiaries. FIG. 5 shows such a form for adding a beneficiary. The user can add the name of the beneficiary and his relationship with the beneficiary. The user can also upload an identity proof and an address proof of the beneficiary. Such identity proof and the address proof can be later used for the verification of the beneficiaries at the time of transferring on the assets. Contact details of the beneficiary can be retrieved from the uploaded identity proof and the address proof. Additionally, the contact details of the beneficiary such as an address, email id, and phone no. can also be manually entered by the user. In one case, the user can only provide an email id of the beneficiary, wherein the beneficiary can be invited through a link send over the email to add their details and upload relevant documents. The user can review the details added by the beneficiary and may optionally provide his approval for the added details by the beneficiary. The beneficiaries can also be provided with an option to provide their consent whether they wish to inherit the assets or not. Moreover, the beneficiaries can also nominate any other person, such as his or her son. Contact details can include address, email id, phone no. and like, such as if one way of reaching the beneficiary fails, the other method of contact can be used. For example, notification about the death of the user can be send through email, SMS, and letter to the beneficiary. Additionally, the contact details of a trusted person can also be added that can inform the beneficiary about the notification. This can be useful when the beneficiary does not have any fixed contact details or cannot be reached by the any of the aforesaid methods. Similar registration form can also be provided to receive information about a business. FIG. 6 shows a form for receiving know your business details from a organization. FIG. 7 shows another form that can be used to add a beneficiary or a trusted contact of the beneficiary.

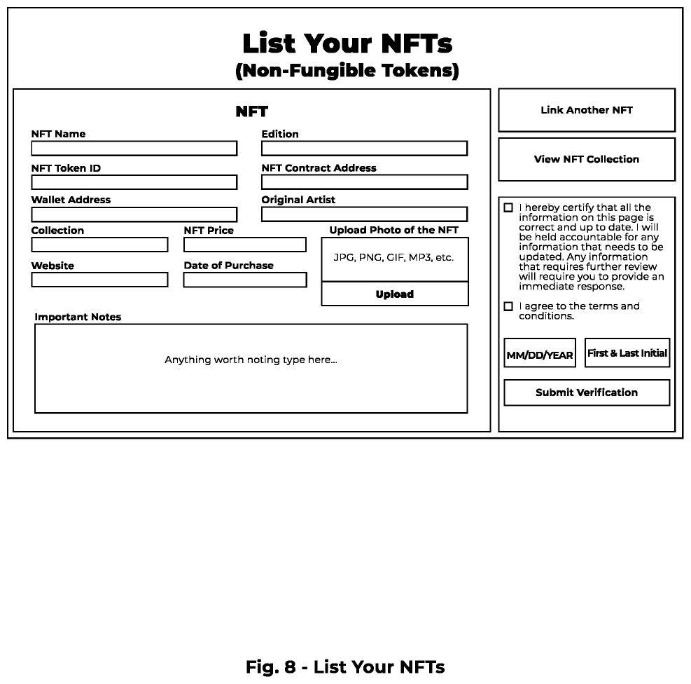

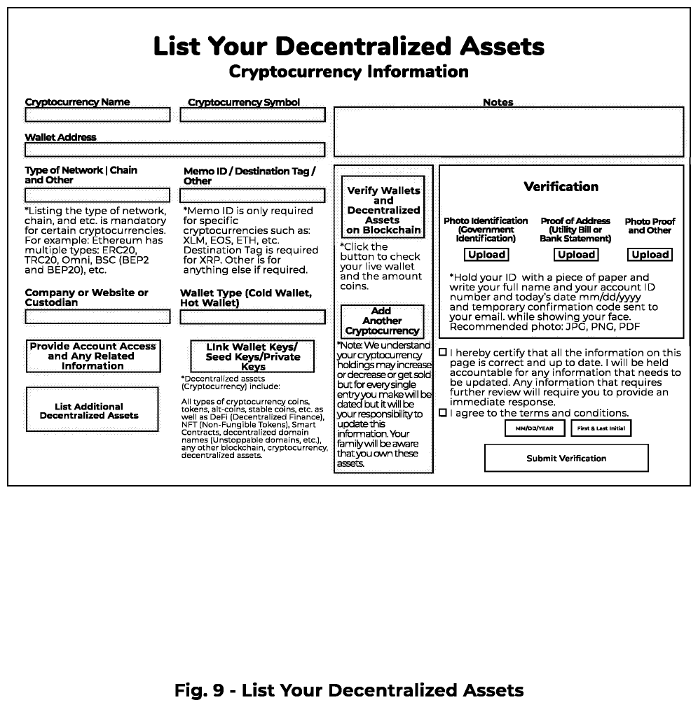

The registration module 260 may also allow providing for suitable APIs and plugins for the user that may monitor the assets of the user. The registration module may also provide for receiving special permissions from the user to transact the assets post-death of the user for transferring the assets to the verified beneficiaries according to the will. For example, suitable APIs can be provided by the registration module to keep track of the assets of the user both national and international. Moreover, APIs can be provided for non-traditional assets like digital currency, wherein the APIs may allow transacting the digital currency to the beneficiary accounts during the transfer of the assets according to the will. The API can receive information from bank servers about the balances. Similarly, the emails and messages of the user can be monitored for statements, similarly API's can be used for brokerage trading accounts, digital wallets, commodities accounts, and like assets which are feasible to be fetched by an API. Like API any other interface can be used that can be bring all the assets under one place. Adding an optional API connection to add platforms such as banking, exchanges, brokerages, or other investment or asset-based companies' systems. This will help bring everything in one place to keep track of your assets. FIG. 8 shows a form implemented within the user interface that may permit a user to add non-traditional assets which is NFTs in FIG. 8. FIG. 9 permits the user to add all types of decentralized assets that are related to cryptocurrency assets details. Can list all information, wallet address, type of wallet (Cold or Hot), list company, custodian, website with access details, add (wallet keys, private keys, seed key, and any sensitive information regarding crypto access in a secure database connected with the attorney), listing the type of network, chain, and etc. is mandatory for certain cryptocurrencies. For example: Ethereum has multiple types: ERC20, TRC20, Omni, BSC (BEP2 and BEP20), etc. Also adding Memo ID is only required for specific cryptocurrencies such as: XLM, EOS, ETH, etc. Destination Tag is required for XRP. Other is for anything else if required. Blockchain verification shows all assets and wallets and amount of with the transactions as shown in FIG. 9.

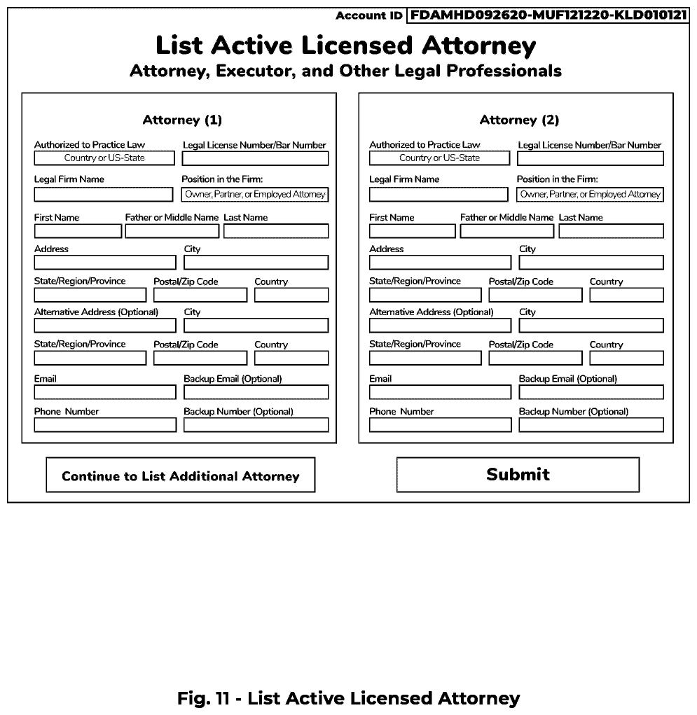

The registration module may also permit registering professionals with the disclosed will management system 100. Professionals, such as attorneys, accountants, and like can register their profile. Users can navigate through the profiles to find desired professionals, for example, a probate attorney to handle the will. For example, the user can appoint a probate attorney already associated with the will management system 100. The users and the professionals upon registration can be provided with a unique identification code that can be used to find the users or professionals on the will management system 100. A user can obtain the unique identification code of his probate attorney and look for him using the code in the will management system 100. The user can also invite the attorney to register with the will management system 100 if not already there. The registration module 260 can receive details of the attorneys including contact details, certification and registrations, and practice areas. The attorneys can make their profile providing more details that may help the user to choose the right attorney as per the requirement. FIG. 11 shows an interface that implements a form to allow listing of an attorney. More than one attorney can be added through the interface shown in FIG. 11.

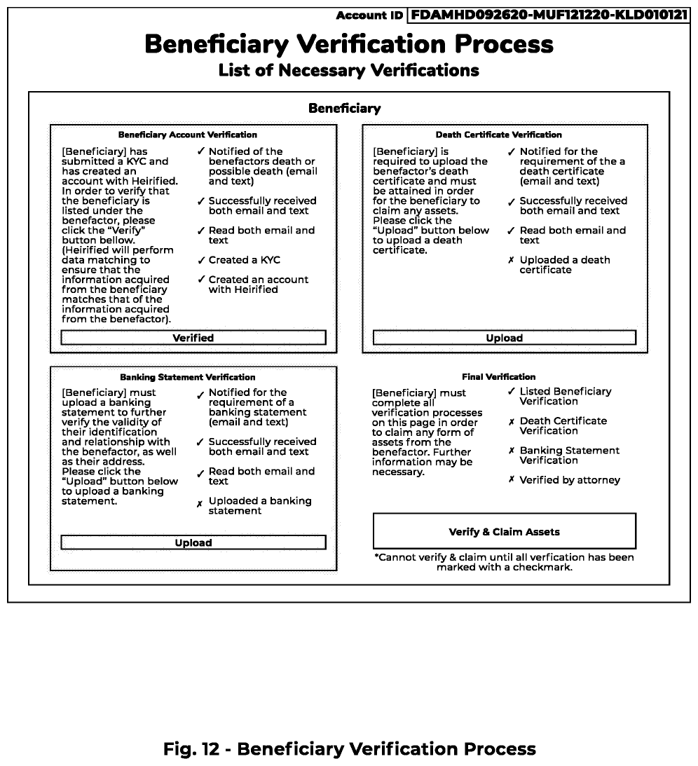

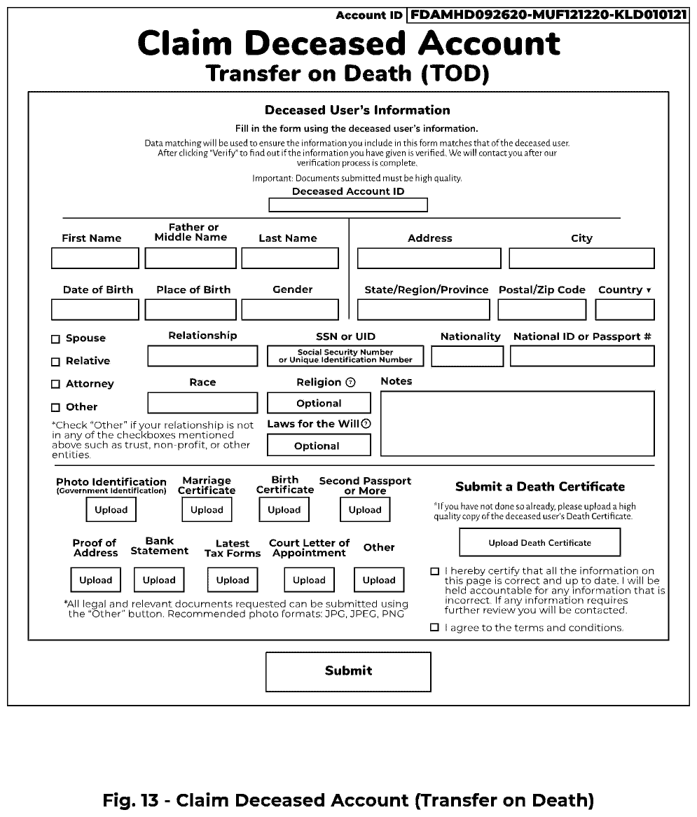

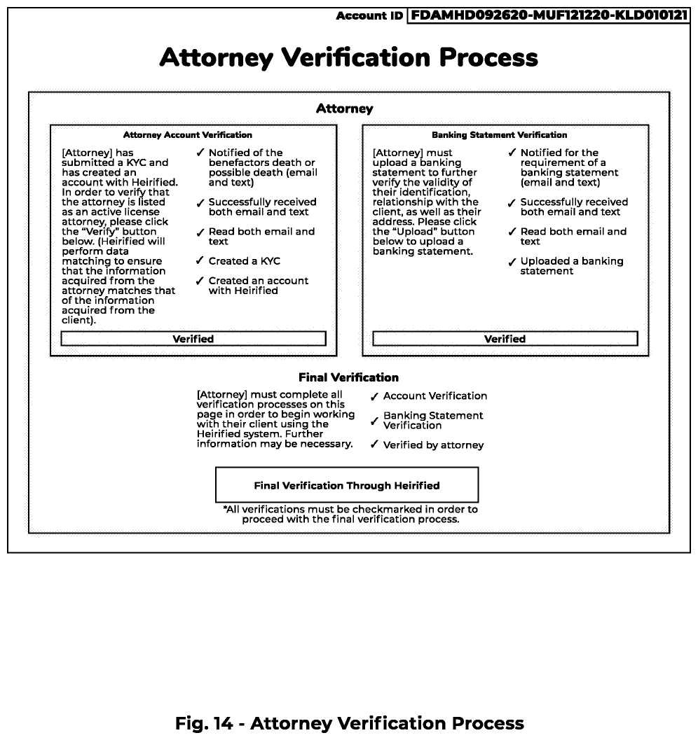

The verification module 270 upon execution by the processor 210 can provide for verification of the user, beneficiaries, and the professionals. The user can be verified based on the documents uploaded by the user, such as know your customer (KYC) or know our business (KYB) verification. Suitable audio and video verification can also be done. Biometrics of the user, such as retina scan, fingerprint, digital face ID, iris/retina/eye biometrics, facial 3D features, body movement, and like biometric information can be collected. The attorney chosen by the user can also provide for the verification of the user, provided the attorney has been verified by the will management system. The verification module through the user interface and the professional interface may allow for verifying the professionals and users. Third-party services can also be taken for the verification process, such as in-person verification. The verification module 270 may also provide for verifying the beneficiaries and periodic verification can also be done to keep the contact details updated. The verification module 270 can keep the contact details of the beneficiaries updated by periodic inquiries. The verification module 270 may also provide for storing one or more biometric data of the beneficiaries that can be useful for authentication during the transfer of non-traditional assets. Persons claiming to be beneficiary after the death of the user can also be verified by the verification module 270. Such person may also submit KYC details and optionally the biometric data. Details shown in the form presented in FIG. 7 can be received from a person claiming to be the beneficiary. Various steps in the verification of the beneficiary by the verification module 270 are shown in FIG. 12. The person claiming to be a beneficiary may also require submitting a form as shown in the interface of FIG. 13. The user can also submit a death certificate of the user, wherein an option can be provided in an interface shown in FIG. 13. The verification module 270 can also provide for the verification of the attorney based on the details received by the registration module. FIG. 14 shows the various steps that may be undertaken by the verification module 270 for verifying each listed attorney.

In one aspect, a user can provide a picture according to the instruction presented on the user interface. The user can be asked to hold a verification ID in hand, such as the id and the face of the user are within the field of view of the camera, the id is visible in the photograph. For example, a driving license upon a paper and written on the paper can be full name, account ID, and date, wherein the verification id and the paper with all the details must be visible in the photograph with the face. For KYC verification, a video of the user can be captured through the user interface, wherein the user can be instructed by presenting step-by-step instructions, such as speaking the name, purpose for KYC, showing photo and address proof, and like.

The draft module 280 upon execution by the processor can provide for the creation of will within the user interface provided by the interface module, both implemented in the will management system 100. The draft module 280 can include audio and video functionalities for creating and authenticating the will. For example, the draft module can record the user and the witnesses signing the will to endorse the authenticity of the will. Besides, the disclosed draft module 280 can also provide for digitally signing the will and any other document submitted to the disclosed will management system 100. The user can also show the will in hand to a camera coupled to the user device as an additional proof of authenticity of the will if later challenged. Similar, the person witnessing the signing of the will and any attorney involved can also be recorded by the disclosed system and/or a third party. Alternatively, the user can get the printed will and other documents notarized before uploading and sending to the attorney.

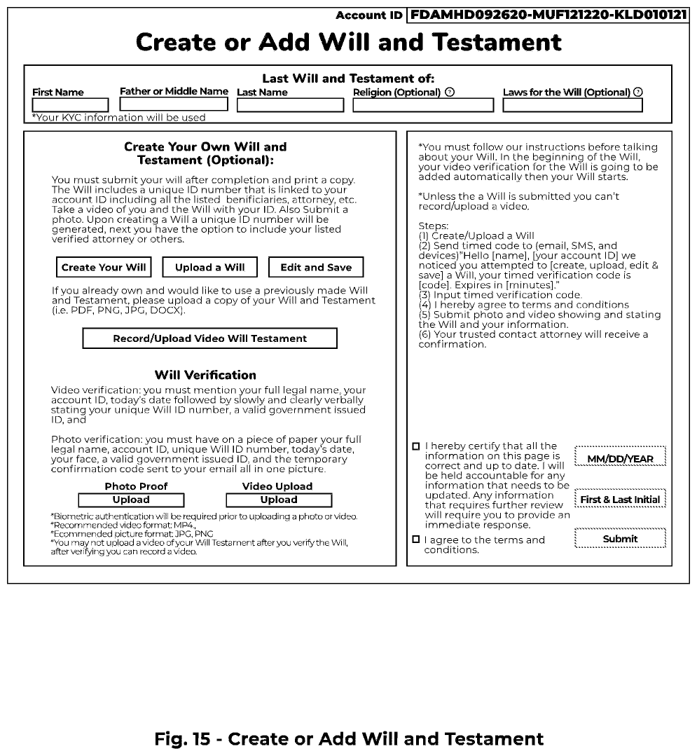

The audio and video functionality of the user interface can be used to make VoIP calls to the family, friends, attorneys, witnesses, beneficiaries, and like. Such VoIP calls can be stored in the databased by the disclosed system with date and time. Such records can be used later for verification and resolve any disputes. FIG. 15 shows an interface for creating the will. As shown in FIG. 15, the user can be provided with an option to create the will or upload an existing will. The uploaded will can also be edited and saved. Option can also be provided for the user to record or upload a video recording of the will testament.

The draft module can retrieve the assets of the user through APIs and plugins. The draft module 280 can retrieve information about the assets from servers of the service providers, such as banking service provides, public servers having registration information for properties, income tax returns, and like. Moreover, draft module 280 can check the email for statements and messages that can be used to retrieve the assets of the user. The draft module 280 not only fetches the details of new assets but can also monitor the old assets for changes and any suspicious activity. All kinds of inheritable assets including traditional and non-traditional assets can be tracked by the disclosed draft module 280 for both creating the will and amending the will with a changed asset. The user or testator may also be required to prove the ownership of assets, and suitable ownership documents can also be received by the disclosed system. In case, such documents are held by the attorney, a list or copy of such ownership document can also be uploaded to the disclosed system.

Although the asset information can be automatically fetched using APIs, the draft module 280 may also receive assets information directly from the user through the user interface implemented by the interface module within the disclosed will management system 100. The draft module 280 can also assist the user in preparing the will wherein predefined templates having placeholders can be used. For example, the predefined templates can be implemented within the user interface that can be implemented by the interface module 250 of the will management system 100. The draft module 280 can fill the placeholder with the name and address of the user from the user details received by the registration module.

The activity of the user while creating the will can be recorded either continuously or at intervals using both audio and video. Such recordings can be able to detect the state of mind of the user while drafting the will. The draft module can ask predefined questions to the user related to the mental wellbeing of the user and such questions and answers can be archived for later use. The questions can be both displayed to the user and broadcasted through a speaker of the user's device. The user can answer both by speaking and selecting the desired answer on the user interface. The mental state can also be included in the will creation t template using predefined language or phrases. Also, such proceedings can be date and time stamped for the record.

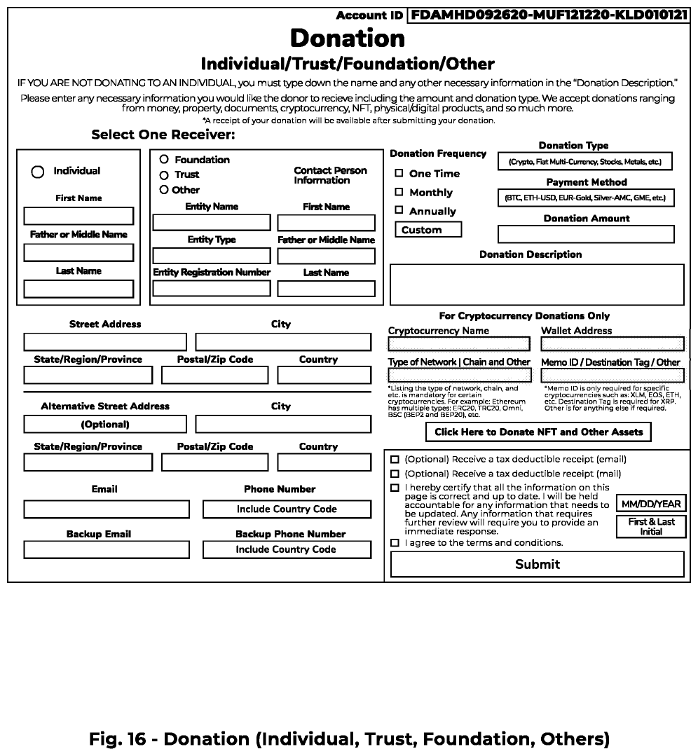

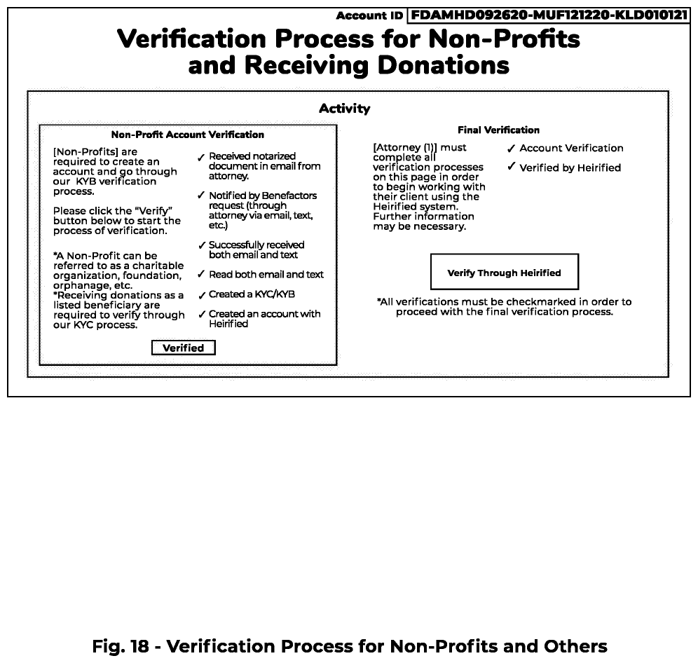

The registration module 260 can also provide for the registration of the charity organizations through an interface generated by interface module 250. The user can select the charity organization as a beneficiary from the available list of the charity organizations within the will management system 100. Alternatively, the user can manually enter the details of a charity organization if not available on the will management system 100. The verification module 270 can also provide for verification of the charity organization to ensure the availability and legality of the beneficiary. FIG. 16 shows a form for donation to an individual, trust, foundation, and non-profit organizations. The user willing to pass donate to charity regularly while alive, setup a trust to donate, and able to donate assets as requested in his or her will. The user/testator will able to choose who to donate too with different types of assets (cryptocurrency, fiat-multi currency, stocks, NFT, etc.) and to choose the frequency from one time, monthly, yearly, or even custom. Able to receive donation receipt through mail, email, SMS, etc. May use receipt from donation as a deductible for tax purposes and connected directly and updated to his accountant, attorney, etc. An accountant can be listed as “other” for different purposes. charity can select the desired charity organization or manually enter any specific trust or organization. Moreover, the users can donate and pass on stable coins 1:1 national pegged to national currency for every country. The listed profiles of the charity organizations can also include additional details such as objectively, work areas, achievements and like that can help the user to decide. The verification module can also provide for verification of the non-profit organizations for receiving the donations. FIG. 18 shows the steps in verification of the non-profit organizations by the verification module 270.

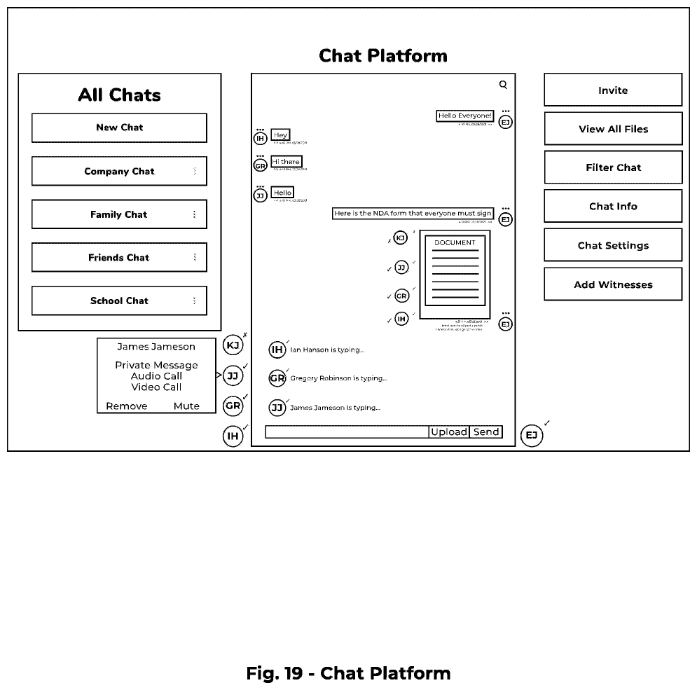

The draft module may also provide a shared workspace for collaborative use by the user and his attorney. For example, the user and the attorney can collectively work on a document, wherein the shared workspace implemented by the interface module within the will management system 100 can allow both the user and attorney to read and edit the document. Different kinds of will creation templates can be provided by the draft module 280 which the user or attorney can navigate through the templates and select a template matching the requirements of the user. The shared workspace can include configurable read and write permissions, such as the user can be provided only view permissions, while the attorney can have both read and view permissions. In one case, the permissions can be decided by the host. The draft module 280 can also provide an option to mark up the changes in the document, and the changes can be tagged with location, account ID, IP address, date, and time. A log can also be prepared and can include details such as the date and time at which the comment is made, or a document is received. Location and IP address can also be logged. A chat feature, as shown in FIG. 19, can also be implemented within the interface that may allow communication between the user and the attorney, wherein such communication can also be tagged with location, account ID, IP address, date, and time, and archived for later use. Although such records can be saved in any secure server, hash files and digital signatures can be used for establishing the authenticity of such records. For example, the generated records in near-real time can be digitally signed or can be secured using blockchain technology. FIG. 1 shows the will management system 100 in communication with a blockchain server 140.

The chat feature of the disclosed draft module can allow users, attorneys, and witnesses to call. Read receipts can also be provide to the participants in a chat to ensure that the other person has read the message. Gestures of the receiver of a message can be monitored to ensure that the user reads the received message, such as eye movements, and such gestures can be used to generate the read receipts. The chat feature also allows the users to see the activities of other users within the same chat. An example, if a person within the chat is typing, all users of the same chat will see the name of the person typing followed by the word “typing” to indicate that the user is typing.

The administrative module 290 upon execution by the processor can provide for the transfer of assets to the beneficiaries. The beneficiaries can be pre-verified within the verification module 270 implemented on the will management system 100. The verification ensures that the assets can be passed on to the right beneficiaries without any hassles for locating, identification, verification, and like procedures known in the art for transfer of the assets. The transfer of assets after the death of the testator can be subjected to state laws applicable to the testator. The disclosed administrative module 290 can take into account the applicable laws and may assist the attorney of the user with desired information for legal proceedings. Assets not under the purview of the state laws, such as the non-traditional assets can be seamlessly transferred to the beneficiaries with or without the approval of the attorney appointed by the testator, based on the state laws. The non-traditional assets has a different process for both ownership and transfer, and the disclosed administrative module 290 can provide a seamless process for the transfer of non-traditional assets to the right beneficiaries. For example, transferring the access details for the non-traditional assets to the beneficiaries. The disclosed administrative module 290 can be compatible with different platforms for transacting non-traditional assets for a quick and easy way for the transfer of such assets. In one case, the disclosed will management system 100 can provide encrypted storage for the access details, wherein the access details can be unlocked only by the beneficiary, such as using the biometric data of the beneficiary.

The administrative module 290 may also provide for safely storing account access details of the user including the username and password. For certain accounts, the transfer may not be possible using APIs or any third-party service. In such cases, the access details can be shared with the beneficiary for gaining access to the assets. The administrative module 290 can keep a track of the change in the access details, for example checking the e-mails of the user for any notification of the change of password. In case, a password change can be detected, the user can be notified to update the access details within the administrative module 290.

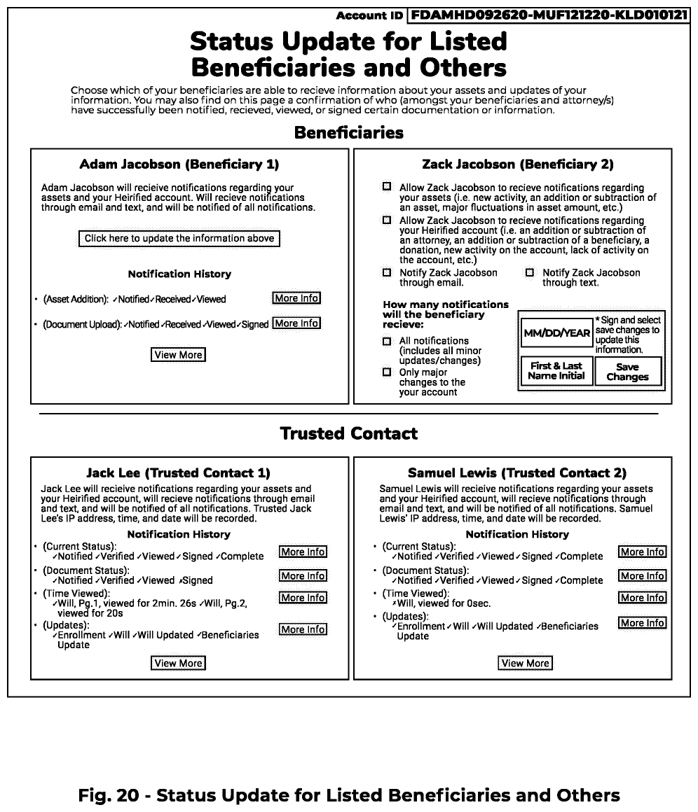

The disclosed will management system 100 may also provide for nominating beneficiaries in a different country and the details of the beneficiaries could be saved. The beneficiaries can be informed by the will management system 100 about the demise of the user and the inheritance. FIG. 20 shows an exemplary embodiment of the interface for the notification status. The user can easily consult and appoint a probate attorney in a different country and execute the will based on the desire of the user. For example, Muslims living in non-sharia law countries can easily appoint beneficiaries in the same or different countries and pass on their assets through Sharia law. More than one attorney can also be appointed to take care of any legalities in the transfer of assets. For example, in case, the user and beneficiary are residents of different countries, attorneys from both countries can be added to advise on any technical difficulties. The disclosed draft module can also raise warnings and notifications while drafting the will about any legal or technical difficulty that may arise from the transfer of assets.

The administrative module may know about the death of the user from public records, hospital records, and like. For example, the administrative module can be triggered by the digital inactivity of the user, such as the phone remains unlocked for the unusual duration, hospital admission, and like. The administrative module 290 can check about the state of the user from the attorney or beneficiaries and can also check any public record for the death certificate of the user. Additionally, the transfer of assets may require prior approval of the attorney appointed by the user.

In one case, one or more features of the will management system 100 can be incorporated in non-traditional assets such as decentralized exchanges and wallets of cryptocurrency, and the non-traditional assets may allow an owner to take on record a nominee for their account.

In one exemplary embodiment, the user can be provided with a master key. The master key can be used in case the user loses login details, such as two factor authentication, the master key can help the user recover login details. Secret questions can also be used to identify the user, such as the user can be given 3-10 questions to answer correctly in order to restore access to their account. RSA Tokens are also known method for secure access, such has two factor authentication. Alternate methods can include identity-based Cryptography which is a public-key that is distributed by a third party and retains the master private key. Customers obtain a private key and seed key (which is derived from the master private key) essentially giving the customer their own “password.” The user can also be required to provide time verification codes. The user can setup a Security key such as yubico, Thetis, etc for extra security but must submit biometric authentication before doing so.

In one exemplary embodiment, disclosed is a system and method for transferring all kinds of assets including traditional assets and non-traditional assets, wherein the assets can be passed globally through a brokerage/trading account, bank account, and digital wallets. The disclosed system can be a borderless, secure, verified, and trusted system to solve a problem of transferring assets globally. The disclosed system can be transparent, wherein the transactions are processed through legal attorneys and attested in presence of witnesses. The disclosed system can deal with different kinds of national and global assets, with full compliance with different state laws applicable to a transaction.

It is to be understood that the disclosed invention can provide for creation and management of the will, however, the disclosed invention can also provide for verification of identity of individuals for any other application. The disclosed system can provide for prevention of frauds and identity of thefts. Moreover, the disclosed system can help to identify an individual for claiming assets. It may happen that a person loose one or more of biometric identity, such as fading fingerprint over time, losing a finger or eye, or a facial surgery. In such case, another biometric data of the user can be used to verify the user. The disclosed system can record more than one biometric data of a user. For example, up to three to five different video verifications can be recorded. The biometric authentication procedure might request more than one for safety. In one case, a user enrolled with the disclosed system can be verified. However, later the person has a cosmetic surgery which changes the features significantly and the person can no longer be identified. The disclosed system can identify the person using other biometric data, and preferably more than one biometric data can be used to verify the person. At the time of enrollment, a user can be requested to add hair color, eye colors, lenses, contacts, and height, and like body parameters. The process may use multiple authentication processes for a single method to prevent fraud. In one case, the disclosed system can also keep a record of a DNA of a person, which can be used as a check, as well as when other means of identification fails. The DNA test can be taken from any certified lab and records maintained. A person claiming to have blood relationship with the testator but not listed as a beneficiary can upload a birth certificate and the DNA results. In one case, if the user dies without listing any beneficiaries, and the user's son claims the assets of the user. The disclosed system can receive KYC and a DNA test to prove that he is the son of the user.

The DNA records and birth certificate can be received from the user and can be used when something is uncertain or extreme case. Other biometrics that can be collected include Face ID, iris scanner, retina scanner, eye scanner, facial 3D scanner verification, body movement scanner verification, fingerprint scanner, thermal technology in fingerprints and thermal technology. The user can have an option to choose the desired biometric methods, and access options.

In one exemplary embodiment, the user can enroll with the disclosed system by providing various identification and biometric details. Not all the details may be needed for KYC verification, but can be used for accessing, identification for different applications, and asset transfer. The user can list the beneficiaries, attorney, trusted contacts, and optionally a trustee. The user can either create the will using the disclosed system or can upload a will created by themselves. Users can list all types of assets: Traditional and non-traditional assets. Any other asset, national or global can be listed, without departing from the scope of the present invention. The disclosed system can track and monitor updates of beneficiaries, attorneys, etc.

According to the present system, dealing with offshore accounts can be very difficult after the death of the owner. For example, the trading accounts located in offshore countries, may have different rules for inheritance or transfer of assets to beneficiaries. Because of this, most of the times such assets may remain unclaimed or freeze. The system can be pre-programed to handle the transfer of such assets. Alternatively, the user can define steps for the transfer of assets. Still alternatively, the user can print the steps to access such trading accounts including the access details. Thus, depending upon the type of asset, the disclosed system can provide a highly safe and secure storage for the access details. Moreover, the user can recover such information in case it is lost. There are no set rules for the borderless cryptocurrency. In many countries, it is still not a valid currency and transfer of such currency to beneficiaries in the same country or a different country can be problematic. For example, Coinbase and Robinhood (at the time of writing this) does not allow listing beneficiaries and some people till this day cannot have access to their deceased family member's account. The disclosed system can remove any uncertainty and legal hurdles in the transfer of assets to the beneficiaries in the same country or a different country.

In one exemplary embodiment, the disclosed biometric based verification can be used for different purposes and spaces such as: know your customer, know your business, Trust & Estate Planning, Inheritance, Asset Management, Legal services, notarization, fintech, banking, finance, technology, charity, institutions, hedge funds, family offices, investment firms, crypto custody, custody, brokerages, insurance, sandbox and signing all agreements for profit and non-profit purposes.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

Smartwatches also offer the ability to track health giving the ability to detect multiple signs of health giving the ability to send the information to the connected brokerage and the listed “trusted person” may be contacted to confirm if the user is sick or deceased before sending an official notice to the listed beneficiaries. For additional security purposes the smart watch can also be used to block certain activities made to their account. The user can limit access to certain devices only, thus notifying the user of any unwarranted use. Listed beneficiaries, attorney, trusted contacts, etc. can also provide all legal document which are subject to verification such as Medical Power of Attorney, power of attorney, etc.

What is claimed is:

1. A method for creating and managing a will, the method implemented on a will management system, the method comprising the steps of:
presenting, a user interface on a user device, by an interface module upon execution by a processor of the will management system, the interface module implemented within the will management system;
receiving, through the user interface, user details, details of one or more beneficiaries, and first details of assets, through the user interface, by a registration module upon execution by the processor, the registration module implemented within the will management system;
fetching, a second details of assets from one or more service provider's servers based on the user details and the first details of assets, by a draft module upon execution by the processor, the draft module implemented within the will management system, the one or more service provider's servers are external to the will management system;
processing, the first details of asset and the second details of assets to obtain a list of assets;
presenting a will creation template implemented within the user interface, by the draft module upon execution by the processor, the will creation template comprises the list of assets and the one or more beneficiaries, the will creation template configured to permit linking one or more assets of the list of assets to the one or more beneficiaries, the will creation template further comprises a plurality of placeholders configured to receive the user details and details of the one or more assets of the list of assets linked to the one or more beneficiaries; and
processing the will creation template with the user details and the details of the one or more assets linked to the one or more beneficiaries to obtain a will.

2. The method according to claim 1, wherein the method further comprises the steps of:
notifying, by an administrative module upon execution by the processor, at least one beneficiary of the one or more beneficiaries about the will, the administrative module implemented within the will management system;
receiving, from the at least one beneficiary, details of the at least one beneficiary, by the administrative module upon execution by the processor; and
transferring, at least one asset of the one or more assets linked to the at least one beneficiary, by the administrative module upon execution by the processor, to the at least one beneficiary.

3. The method according to claim 2, wherein the at least one asset is a non-traditional asset.

4. The method according to claim 3, wherein the method further comprises the steps of:
receiving access details, through the user interface, by the registration module upon execution by the processor, the access details configured to provide access to the at least one asset,
wherein the access details are transferred by the administrative module to the at least one beneficiary.

5. The method according to claim 4, wherein the method further comprises the step of:
upon receiving the details of the at least one beneficiary, also receiving by the administrative module, at least one biometric data of the at least one beneficiary, wherein the access details are unencrypted based on the at least one biometric data of the at least one beneficiary, by the administrative module upon execution by the processor.

6. The method according to claim 5, wherein the method further comprises the steps of:
providing an attorney interface, by the interface module upon execution by the processor;
receiving a verification of the details of the at least one beneficiary through the attorney interface; and
receiving an approval for the transferring of the at least one asset to the at least one beneficiary, through the attorney interface, wherein the transfer is made upon receiving the approval.

7. The method according to claim 1, wherein the method further comprises the steps of:
while processing the will creation template, capturing an audio and a video of a user through a camera and a microphone coupled to the user device; and
determining, a mental state of the user by analyzing the audio and the video.

8. The method according to claim 1, wherein the method further comprises the steps of:
tracking a change in the list of assets by the draft module upon execution by the processor;
receiving, an amendment in the will through the user interface, by the draft module; and
processing the amendment to obtain a revised will.

9. The method according to claim 5, wherein the method further comprises the steps of:
providing an attorney interface, by the interface module upon execution by the processor;
receiving the will, by the attorney interface, wherein the attorney interface configured to permit editing of the will to obtain an edited will;
receiving, from the attorney interface the edited will or an acknowledgment of the receiving of the will; and
presenting, on the user interface, the edited will or the acknowledgment.

10. A method for managing a will and transfer of assets, the method implemented on a will management system, the method comprising the steps of:
presenting, a user interface on a user device, by an interface module upon execution by a processor of the will management system, the interface module implemented within the will management system;
receiving, through the user interface, user details, details of one or more beneficiaries, and a will, through the user interface, by a registration module upon execution by the processor, the registration module implemented within the will management system, the user details comprise a visual identification document and an address proof; the details of one or more beneficiaries comprise a visual identification document and an address proof;
verifying the user details and the details of the one or more beneficiaries; and
receiving an image of a user showing the will to a camera coupled to the user device.

11. The method according to claim 10, wherein the method further comprises the steps of:
notifying, by an administrative module upon execution by the processor, at least one beneficiary of the one or more beneficiaries about the will, the administrative module implemented within the will management system;
receiving, from the at least one beneficiary, details of the at least one beneficiary, by the administrative module upon execution by the processor; and
transferring, at least one asset of the user linked to the at least one beneficiary, by the administrative module upon execution by the processor, to the at least one beneficiary.

12. The method according to claim 11, wherein the at least one asset is a non-traditional asset.

13. The method according to claim 12, wherein the method further comprises step of:
receiving access details, through the user interface, by the registration module upon execution by the processor, the access details configured to provide access to the non-traditional asset,
wherein the access details transferred by the administrative module to the at least one beneficiary.

14. The method according to claim 13, wherein the method further comprises the step of:
upon receiving the details of the at least one beneficiary, also receiving by the administrative module, at least one biometric data of the at least one beneficiary, wherein the access details are unencrypted based on the at least one biometric data of the at least one beneficiary, by the administrative module upon execution by the processor.

15. The method according to claim 14, wherein the method further comprises the steps of:
providing an attorney interface, by the interface module upon execution by the processor;
receiving a verification of the details of the at least one beneficiary through the attorney interface; and
receiving an approval for the transferring of the at least one asset to the at least one beneficiary, through the attorney interface, wherein the transfer is made upon receiving the approval.
